(19) United States
(12) Patent Application Publication
(10) Pub. No.: US 2023/0373799 A1
(43) Pub. Date: Nov. 23, 2023

(54) ZEOLITE MEMBRANE COMPLEX, SEPARATION APPARATUS, MEMBRANE REACTOR, AND METHOD OF PRODUCING ZEOLITE MEMBRANE COMPLEX

(71) Applicant: NGK INSULATORS, LTD., Nagoya-City (JP)

(72) Inventors: Ko KOBAYASHI, Nagoya-City (JP); Makoto MIYAHARA, Tajimi-City (JP); Kenichi NODA, Nagoya-City (JP)

(73) Assignee: NGK INSULATORS, LTD., Nagoya-City (JP)

(21) Appl. No.: 18/361,991

(22) Filed: Jul. 31, 2023

Related U.S. Application Data
(63) Continuation of application No. PCT/JP2022/006116, filed on Feb. 16, 2022.

(30) Foreign Application Priority Data
Mar. 10, 2021 (JP) 2021-038089

(51) Int. Cl. C01B 39/46; C01D 17/00; B01D 69/10

(52) U.S. Cl. CPC C01B 39/46; C01D 17/003; B01D 69/108

(57) ABSTRACT

A zeolite membrane complex includes a porous support and a zeolite membrane formed on the support and composed of ETL-type zeolite. In an X-ray diffraction pattern obtained by X-ray irradiation onto a surface of the zeolite membrane, an intensity of a peak existing in the vicinity of 2θ=9.9° and an intensity of a peak existing in the vicinity of 2θ=19.8° are each not lower than 0.8 times an intensity of a peak existing in the vicinity of 2θ=7.9°.

### CROSS-REFERENCE TO RELATED APPLICATIONS

The present application is a continuation application of International Application No. PCT/JP2022/6116 filed on Feb. 16, 2022, which claims priority to Japanese Patent Application No. 2021-38089 filed on Mar. 10, 2021. The contents of these applications are incorporated herein by reference in their entirety.

### TECHNICAL FIELD

The present invention relates to a zeolite membrane complex, a separation apparatus, a membrane reactor, and a method of producing a zeolite membrane complex.

### BACKGROUND ART

Zeolites having various structures are well known, and one of them is ETL-type zeolite. In U.S. Pat. No. 4,581,211 (Document 1), “Synthesis, properties, and catalytic behavior of zeolite EU-12” by Abraham Araya and five others (ZEOLITES, 1992, Vol. 12, pp. 24-31) (Document 2), and “EU-12: A Small-Pore, High-Silica Zeolite Containing Sinusoidal Eight-Ring Channels” by Juna Bae and four others (Angew. Chem. Int. Ed., 2016, Vol. 55, pp. 7369-7373) (Document 3), disclosed is a method of synthesizing ETL-type zeolite crystal (EU-12) powder by hydrothermal synthesis.

When the inventor of the present application uses a starting material solution for synthesizing EU-12 to form a zeolite membrane on a support, the obtained ETL-type zeolite membrane has low denseness and desired separation performance cannot be obtained. Therefore, a zeolite membrane complex having an ETL-type zeolite membrane with increased denseness is required.

### SUMMARY OF THE INVENTION

The present invention is intended for a zeolite membrane complex, and it is an object of the present invention to provide a zeolite membrane complex having an ETL-type zeolite membrane with increased denseness.

The zeolite membrane complex according to one preferred embodiment of the present invention includes a porous support and a zeolite membrane formed on the support and composed of ETL-type zeolite. In the zeolite membrane complex, in an X-ray diffraction pattern obtained by X-ray irradiation onto a surface of the zeolite membrane, an intensity of a peak existing in vicinity of 2θ=9.9° and an intensity of a peak existing in vicinity of 2θ=19.8° are each not lower than 0.8 times an intensity of a peak existing in vicinity of 2θ=7.9°.

According to the present invention, it is possible to provide a zeolite membrane complex having an ETL-type zeolite membrane with increased denseness.

Preferably, in the X-ray diffraction pattern, the intensity of the peak existing in vicinity of 2θ=9.9° and the intensity of the peak existing in vicinity of 2θ=19.8° are each not lower than 1.0 times the intensity of the peak existing in vicinity of 2θ=7.9°.

Preferably, in the zeolite membrane, a molar ratio of silicon/aluminum is not lower than 3.

Preferably, in the zeolite membrane, CF₄ gas permeance is not higher than 10 nmol/m²·s·Pa.

The present invention is also intended for a separation apparatus. The separation apparatus according to one preferred embodiment of the present invention includes the above-described zeolite membrane complex and a supply part for supplying a mixed substance containing a plurality of types of gases or liquids to the zeolite membrane complex. In the separation apparatus, the zeolite membrane complex separates a high permeability substance having a high permeability in the mixed substance from other substances by allowing the high permeability substance to permeate the zeolite membrane complex.

The present invention is still also intended for a membrane reactor. The membrane reactor according to one preferred embodiment of the present invention includes the above-described zeolite membrane complex, a catalyst for accelerating a chemical reaction of a starting material, a reactor that includes the zeolite membrane complex and the catalyst, and a supply part for supplying the starting material to the reactor. In the membrane reactor, the zeolite membrane complex separates a high permeability substance having a high permeability in a mixed substance from other substances by allowing the high permeability substance to permeate the zeolite membrane complex, and the mixed substance contains a product substance generated by a chemical reaction of the starting material under existence of the catalyst.

The present invention is yet also intended for a method of producing a zeolite membrane complex. The method of producing a zeolite membrane complex according to one preferred embodiment of the present invention includes a) depositing seed crystals composed of ETL-type zeolite, onto a porous support and b) forming a zeolite membrane on the support by immersing the support in a starting material solution and performing hydrothermal synthesis to grow ETL-type zeolite from the seed crystals. In the method of producing a zeolite membrane complex, in the starting material solution, a molar ratio of silicon/aluminum is 10 to 100, a molar ratio of alkali metal/aluminum is 15 to 100, and a molar ratio of water/aluminum is 2000 to 10000.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a cross-sectional view of a zeolite membrane complex;

FIG. 2 is a cross-sectional view enlargedly showing part of the zeolite membrane complex;

FIG. 3 is a view showing an X-ray diffraction pattern obtained from a surface of a zeolite membrane;

FIG. 4 is a SEM image showing the surface of the zeolite membrane;

FIG. 5 is a flowchart showing a flow for producing the zeolite membrane complex;

FIG. 6 is a diagram showing a separation apparatus; and

FIG. 7 is a flowchart showing a flow for separating a mixed substance.

### DETAILED DESCRIPTION

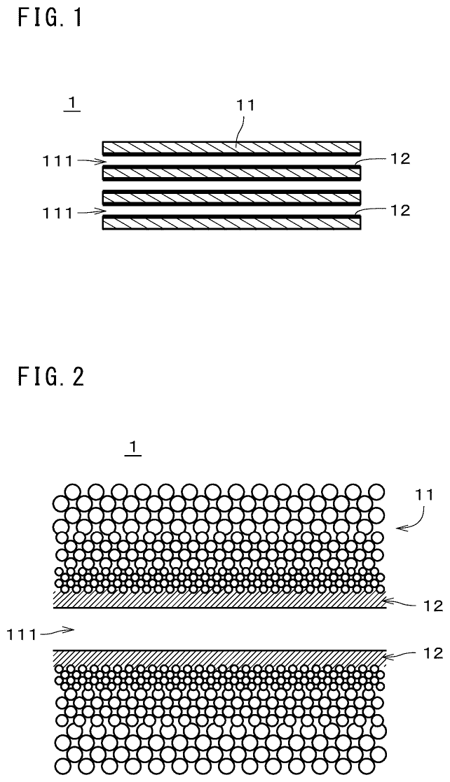

FIG. 1 is a cross-sectional view showing a zeolite membrane complex 1. FIG. 2 is a cross-sectional view enlargedly showing part of the zeolite membrane complex 1. The zeolite membrane complex 1 includes a porous support 11 and a zeolite membrane 12 formed on the support 11. A zeolite membrane is at least obtained by forming zeolite on a surface of the support 11 in a membrane form and does not include a membrane obtained by simply dispersing zeolite particles in an organic membrane. In FIG. 1, the zeolite membrane 12 is represented by a thick line. In FIG. 2, the zeolite membrane 12 is hatched. Further, in FIG. 2, the thickness of the zeolite membrane 12 is shown larger than the actual thickness.

The support 11 is a porous member that gas and liquid can permeate. In the exemplary case shown in FIG. 1, the support 11 is a monolith-type support having an integrally and continuously molded columnar main body with a plurality of through holes 111 extending in a longitudinal direction (i.e., a left and right direction in FIG. 1). In the exemplary case shown in FIG. 1, the support 11 has a substantially columnar shape. A cross section perpendicular to the longitudinal direction of each of the through holes 111 (i.e., cells) is, for example, substantially circular. In FIG. 1, the diameter of each through hole 111 is larger than the actual diameter, and the number of through holes 111 is smaller than the actual number. The zeolite membrane 12 is formed on an inner surface of each through hole 111, covering substantially the entire inner surface of the through hole 111.

The length of the support 11 (i.e., the length in the left and right direction of FIG. 1) is, for example, 10 cm to 200 cm. The outer diameter of the support 11 is, for example, 0.5 cm to 30 cm. The distance between the central axes of adjacent through holes 111 is, for example, 0.3 mm to 10 mm. The surface roughness (Ra) of the support 11 is, for example, 0.1 μm to 5.0 μm, and preferably 0.2 μm to 2.0 μm. Further, the shape of the support 11 may be, for example, honeycomb-like, flat plate-like, tubular, cylindrical, columnar, polygonal prismatic, or the like. When the support 11 has a tubular or cylindrical shape, the thickness of the support 11 is, for example, 0.1 mm to 10 mm.

As the material for the support 11, various materials (for example, ceramics or a metal) can be adopted only if the materials ensure chemical stability in the process step of forming the zeolite membranes 12 on the surface thereof. In the present preferred embodiment, the support 11 is formed of a ceramic sintered body. Examples of the ceramic sintered body which is selected as a material for the support 11 include alumina, silica, mullite, zirconia, titania, yttria, silicon nitride, silicon carbide, and the like. In the present preferred embodiment, the support 11 contains at least one type of alumina, silica, and mullite.

The support 11 may contain an inorganic binder. As the inorganic binder, at least one of titania, mullite, easily sinterable alumina, silica, glass frit, a clay mineral, and easily sinterable cordierite can be used.

The average pore diameter of the support 11 is, for example, 0.01 μm to 70 μm, and preferably 0.05 μm to 25 μm. The average pore diameter of the support 11 in the vicinity of the surface on which the zeolite membrane 12 is formed is 0.01 μm to 1 μm, and preferably 0.05 μm to 0.5 μm. The average pore diameter can be measured by using, for example, a mercury porosimeter, a perm porometer, or a nano-perm porometer. Regarding the pore diameter distribution of the entire support 11 including the surface and the inside thereof, D5 is, for example, 0.01 μm to 50 μm, D50 is, for example, 0.05 μm to 70 μm, and D95 is, for example, 0.1 μm to 2000 μm. The porosity of the support 11 in the vicinity of the surface on which the zeolite membrane 12 is formed is, for example, 20% to 60%.

The support 11 has, for example, a multilayer structure in which a plurality of layers with different average pore diameters are layered in a thickness direction. The average pore diameter and the sintered grain diameter in a surface layer including the surface on which the zeolite membrane 12 is formed are smaller than those in layers other than the surface layer. The average pore diameter in the surface layer of the support 11 is, for example, 0.01 μm to 1 μm, and preferably 0.05 μm to 0.5 μm. When the support 11 has a multilayer structure, the materials for the respective layers can be those described above. The materials for the plurality of layers constituting the multilayer structure may be the same as or different from one another.

The zeolite membrane 12 is a porous membrane having micropores. The zeolite membrane 12 can be used as a separation membrane for separating a specific substance from a mixed substance containing a plurality of types of substances, by using a molecular sieving function. As compared with the specific substance, any one of the other substances is harder to permeate the zeolite membrane 12. In other words, the permeance of any other substance through the zeolite membrane 12 is smaller than that of the above-described specific substance.

The thickness of the zeolite membrane 12 is, for example, 0.05 μm to 30 μm. The thickness of the zeolite membrane 12 is preferably not larger than 10 μm, more preferably not larger than 5 μm, and further preferably not larger than 3 μm. When the thickness of the zeolite membrane 12 is reduced, the permeance of a high permeability substance described later increases. The thickness of the zeolite membrane 12 is preferably not smaller than 0.1 μm, and more preferably not smaller than 0.5 μm. When the thickness of the zeolite membrane 12 is increased, the separation performance increases. The surface roughness (Ra) of the zeolite membrane 12 is, for example, 5 μm or less, preferably 2 μm or less, more preferably 1 μm or less, and further preferably 0.5 μm or less.

The grain diameter of the zeolite grains composing the zeolite membrane 12 is, for example, 0.01 μm to 20 μm, preferably 0.05 μm to 10 μm, and more preferably 0.1 μm to 5 μm. The grain diameter of the zeolite grains is obtained by observing a surface of the zeolite membrane 12 by the scanning electron microscope (SEM) with a magnification of 3000 times, obtaining respective grain diameters (arithmetic averages of short diameters and long diameters) of arbitrary twenty zeolite grains, and performing an arithmetic average of the obtained grain diameters of the twenty zeolite grains.

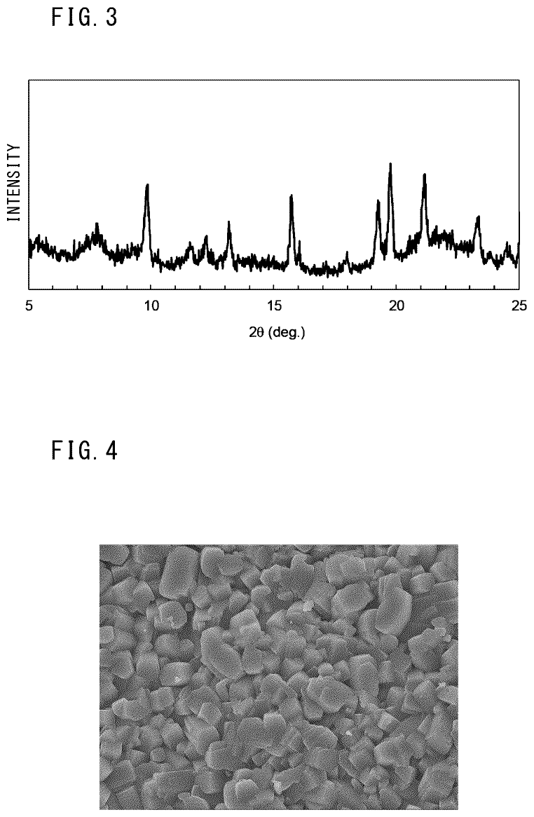

The zeolite membrane 12 is composed of zeolite having an ETL-type structure. In other words, the zeolite membrane 12 is composed of zeolite having a structure code of “ETL” which is designated by the International Zeolite Association. A later-described X-ray diffraction pattern shown in FIG. 3, which is obtained from the surface of the zeolite membrane 12, coincides in the positions of peaks with an X-ray diffraction pattern assumed from the structure of ETL-type zeolite. The zeolite membrane 12 is typically composed only of ETL-type zeolite, but depending on the production method or the like, any substance other than the ETL-type zeolite may be contained slightly (for example, 1 mass % or less) in the zeolite membrane 12.

The maximum number of membered rings of the ETL-type zeolite is 8, and herein an arithmetic average of the short diameters and the long diameters of 8-membered ring pores is defined as the average pore diameter. The 8-membered ring pore refers to a micropore in which the number of oxygen atoms in the part where the oxygen atoms and later-described T atoms are bonded to form a ring structure is 8. The ETL-type zeolite has three types of 8-membered ring pores, and respective pore diameters thereof are 0.27 nm×0.50 nm, 0.28 nm×0.46 nm, and 0.33 nm×0.48 nm and the average pore diameter is 0.39 nm. The average pore diameter of the zeolite membrane 12 is smaller than that of the support 11 in the vicinity of the surface on which the zeolite membrane 12 is formed.

One example of the ETL-type zeolite composing the zeolite membrane 12 is aluminosilicate zeolite in which atoms (T-atoms) each located at the center of an oxygen tetrahedron (TO₄) constituting the zeolite consist of silicon (Si) and aluminum (Al). Some of the T-atoms may be replaced by any other element (gallium, titanium, vanadium, iron, zinc, tin, or the like). This makes it possible to change a pore diameter or adsorption properties.

In the zeolite membrane 12, a molar ratio of silicon/aluminum (which is a value obtained by dividing the number of moles of silicon atoms by the number of moles of aluminum atoms, and the same applies to the following) is preferably not lower than 3, more preferably not lower than 5, and further preferably not lower than 10. This improves the heat resistance and the acid resistance of the zeolite membrane 12. The upper limit of the molar ratio of silicon/aluminum is not particularly limited but is, for example, 100,000. The molar ratio of silicon/aluminum can be measured by the EDS (energy dispersive X-ray spectroscopic analysis). By adjusting the mixing ratio in a starting material solution described later, or the like, it is possible to adjust the molar ratio of silicon/aluminum in the zeolite membrane 12 (the same applies to the ratio of any other elements). As a matter of course, the ETL-type zeolite is not limited to the aluminosilicate-type one.

Typically, the zeolite membrane 12 contains an alkali metal. In the zeolite membrane 12, a molar ratio of alkali metal/aluminum is preferably 0.01 to 1, and more preferably 0.1 to 1. This can stabilize the structure of the ETL-type zeolite. When the zeolite membrane 12 contains a plurality of types of alkali metals, the molar ratio of alkali metal/aluminum is a molar ratio of the total of all alkali metals contained in the zeolite membrane 12 to aluminum. The alkali metal is, for example, rubidium (Rb) or sodium (Na). The zeolite membrane 12 may contain both rubidium and sodium. The zeolite membrane 12 may contain any other alkali metal such as potassium (K), cesium (Cs), or the like. Further, some or all of the cations may be replaced by proton (H⁺), ammonium ion (NH₄⁺) ion, or the like by ion exchange or the like.

One example of the zeolite membrane 12 is produced by using an organic substance termed a structure-directing agent (hereinafter, also referred to as an “SDA”). In this case, it is preferable that after forming the zeolite membrane 12, the SDA should be almost or completely removed. In the zeolite membrane 12, pores are thereby appropriately obtained. As the SDA, for example, tetramethylammonium hydroxide or the like can be used. The zeolite membrane 12 may be produced by not using the SDA.

In the zeolite membrane 12, the CF₄ gas permeance is preferably not higher than 10 nmol/m²·s·Pa, more preferably not higher than 5 nmol/m²·s·Pa, and further preferably not higher than 1 nmol/m²·s·Pa. Thus, since the CF₄ gas hardly permeates the zeolite membrane 12, it can be said that the zeolite membrane 12 has high denseness. Though the CF₄ gas permeance is measured in the zeolite membrane 12 not containing the SDA in the present preferred embodiment, since the CF₄ gas cannot permeate the pores of the ETL-type zeolite in principle, the zeolite membrane 12 may contain the SDA in the measurement of the CF₄ gas permeance.

FIG. 3 is a view showing one example of an X-ray diffraction pattern obtained by X-ray irradiation onto the surface of the zeolite membrane 12. As the X-ray diffraction pattern, used is a pattern obtained by irradiation of CuKα ray, as a radiation source from an X-ray diffraction apparatus, onto the surface of the zeolite membrane 12 from which the SDA is almost or completely removed as described later. Since the intensities of some peaks are different, the zeolite membrane 12 from which the SDA is not removed cannot be used for obtaining the X-ray diffraction pattern. As described earlier, the X-ray diffraction pattern obtained from the zeolite membrane 12 coincides in the positions of the peaks with the X-ray diffraction pattern assumed from the structure of ETL-type zeolite.

In the X-ray diffraction pattern of the zeolite membrane 12, the intensity of a peak existing in the vicinity of 2θ=9.9° and the intensity of a peak existing in the vicinity of 2θ=19.8° are each not lower than 0.8 times the intensity of a peak existing in the vicinity of 2θ=7.9°. The peak in the vicinity of 2θ=9.9° is a peak existing in a range of 2θ=9.9°±0.2° and is derived from the (002) plane of the ETL-type zeolite. The peak in the vicinity of 2θ=19.8° is a peak existing in a range of 2θ=19.8°±0.2° and is derived from the (004) plane thereof. The peak in the vicinity of 2θ=7.9° is a peak existing in a range of 2θ=7.9°±0.2° and is derived from the (021) plane thereof.

Thus, in the zeolite membrane 12, the intensity of the peak derived from the (002) plane of the ETL-type zeolite and the intensity of the peak derived from the (004) plane thereof are relatively high, and the zeolite membrane 12 is an oriented membrane in which the c-axis of constituent grains thereof is oriented in a direction substantially perpendicular to the membrane surface. In the zeolite membrane 12, since the crystal orientations of the zeolite grains are aligned, the zeolite grains become easier to be bonded to one another substantially planarly. Therefore, in the zeolite membrane 12, as shown in the SEM image of FIG. 4, it is hard to occur a gap between adjacent zeolite grains and the denseness is increased. As a result, in the zeolite membrane complex 1, high separation performance is achieved.

In the X-ray diffraction pattern, the intensity of the peak existing in the vicinity of 2θ=9.9° and the intensity of the peak existing in the vicinity of 2θ=19.8° are each preferably not lower than 1.0 times the intensity of the peak existing in the vicinity of 2θ=7.9°, and more preferably not lower than 3.0 times. This further increases the denseness of the zeolite membrane 12. In the exemplary case shown in FIG. 3, the intensity of the peak existing in the vicinity of 20=19.8° is higher than the intensity of the peak existing in the vicinity of 2θ=9.9° and is maximum among all the peaks. The upper limit of the intensity ratio of these peaks is not particularly limited but is, for example, the intensity of the peak existing in the vicinity of 2θ=9.9° and the intensity of the peak existing in the vicinity of 2θ=19.8° are each not higher than 1000 times the intensity of the peak existing in the vicinity of 2θ=7.9°. Further, it is assumed that the peak intensity uses a height of the X-ray diffraction pattern except a line of a bottom thereof, i.e., a background noise component. The line of the bottom in the X-ray diffraction pattern can be obtained, for example, by the Sonneveld-Visser method or a spline interpolation method.

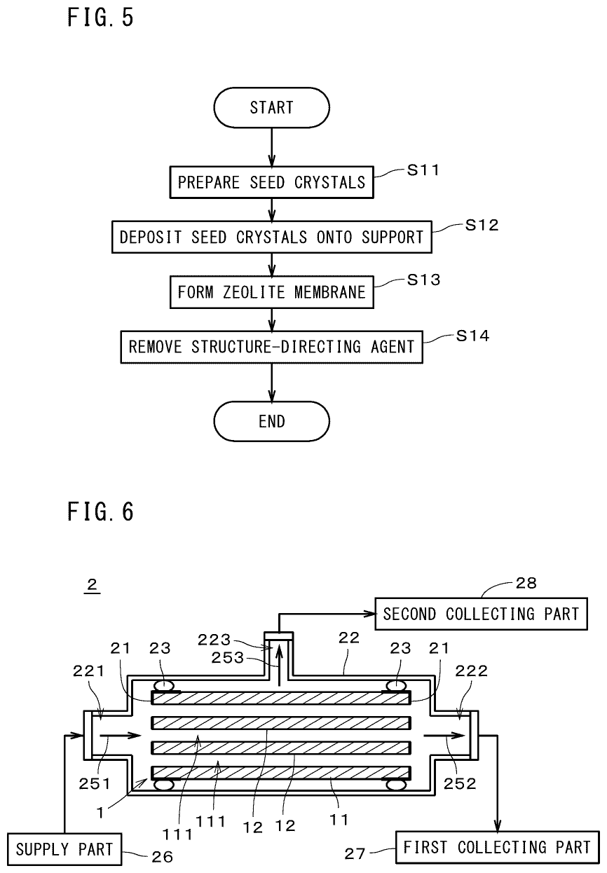

Next, with reference to FIG. 5, an exemplary flow of producing the zeolite membrane complex 1 will be described. In the production of the zeolite membrane complex 1, first, seed crystals to be used for production of the zeolite membrane 12 are prepared (Step S11). For example, ETL-type zeolite powder is synthesized by hydrothermal synthesis, and the seed crystals are acquired from the zeolite powder. The ETL-type zeolite powder may be synthesized by any or well-known production method (for example, the method disclosed in above-described Document 1, Document 2, or Document 3). The zeolite powder itself may be used as the seed crystals, or may be processed by pulverization or the like, to thereby acquire the seed crystals. As the seed crystals, the ETL-type zeolite containing the SDA may be used or the ETL-type zeolite not containing the SDA may be used. The ETL-type zeolite not containing the SDA can be obtained typically by synthesis using the SDA and then burning or the like to remove the SDA.

Subsequently, a porous support 11 is immersed in a dispersion liquid in which the seed crystals are dispersed, and the seed crystals are thereby deposited onto the support 11 (Step S12). Alternatively, the dispersion liquid in which the seed crystals are dispersed is brought into contact with a portion on the support 11 where the zeolite membrane 12 is to be formed, and the seed crystals are thereby deposited onto the support 11. A support with seed crystals deposited is thereby produced. At that time, for example, the concentration of the seed crystals in the dispersion liquid, or the like, is adjusted so that, in the portion of the support 11 on which the zeolite membrane 12 is to be formed, the mass of the seed crystals to be deposited per unit area should be not smaller than a predetermined value. The seed crystals may be deposited onto the support 11 by any other method.

The support 11 on which the seed crystals are deposited is immersed in a starting material solution. The starting material solution is produced by dissolving or dispersing, for example, a silicon source, an aluminum source, an alkali metal source, the SDA, or the like in water serving as a solvent. The silicon source is, for example, colloidal silica, fumed silica, sodium silicate, silicon alkoxide, water glass, or the like. The aluminum source is, for example, aluminum hydroxide, sodium aluminate, aluminum alkoxide, or the like. The alkali metal source contains, for example, a rubidium source, a sodium source, or the like, and may contain both the rubidium source and the sodium source. Further, the alkali metal source may contain a compound containing any alkali metal other than rubidium or sodium. The rubidium source is, for example, rubidium hydroxide, rubidium chloride, or the like. The sodium source is, for example, sodium hydroxide, sodium chloride, or the like. The SDA is, for example, tetramethylammonium hydroxide, choline chloride, or the like.

In the starting material solution, the molar ratio of silicon/aluminum is 10 to 100, preferably 10 to 75, and more preferably 15 to 50. The molar ratio of alkali metal/aluminum (the molar ratio of the total alkali metals contained in the starting material solution to aluminum) is 15 to 100, preferably 15 to 80, and more preferably 20 to 70. The molar ratio of water/aluminum is 2000 to 10000, preferably 2500 to 10000, and more preferably 3000 to 8000. The molar ratio of SDA/aluminum is, for example, 2 to 100, preferably 3 to 70, and more preferably 3 to 50. The starting material solution may not contain the SDA. Any other raw material may be mixed in the starting material solution, and any substance other than water may be used as the solvent of the starting material solution.

After the immersion of the support 11 in the starting material solution, the ETL-type zeolite is caused to grow from the seed crystals on the support 11 as nuclei by the hydrothermal synthesis, to thereby form the ETL-type zeolite membranes 12 on the support 11 (Step S13). The temperature in the hydrothermal synthesis is preferably 110 to 230° C. The time for hydrothermal synthesis is preferably 5 to 100 hours. As the time for hydrothermal synthesis becomes shorter, the production cost of the zeolite membrane complex 1 can be reduced.

After the hydrothermal synthesis is finished, the support 11 and the zeolite membrane 12 are washed with pure water. The support 11 and the zeolite membrane 12 after being washed are dried at, for example, 100° C. After the support 11 and the zeolite membrane 12 are dried, a heat treatment is performed on the zeolite membrane 12 under an oxidizing gas atmosphere, to thereby burn and remove the SDA in the zeolite membrane 12 (Step S14). This results in the formation of through micropores in the zeolite membrane 12. Preferably, the SDA is almost or completely removed. The heating temperature in the removal of the SDA is, for example, 400 to 1000° C. The heating time is, for example, 1 to 100 hours. The oxidizing gas atmosphere is an atmosphere containing oxygen, such as air. Through the above-described process, the dense zeolite membrane 12 is formed, and the above-described zeolite membrane complex 1 having high separation performance is produced.

Ion exchange may be performed on the zeolite membrane 12 as necessary. As the ions for exchange, proton, ammonium ion, alkali metal ion such as Na⁺, K⁺, Li⁺, or the like, alkaline earth metal ion such as Ca²⁺, Mg²⁺, Sr²⁺, Ba²⁺, or the like, and transition metal ion such as Fe²⁺, Fe³⁺, Cu²⁺, Zn²⁺, Ag⁺, or the like may be used.

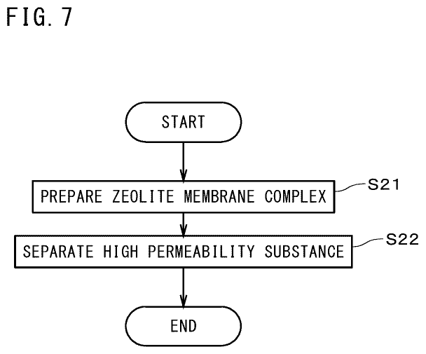

Next, with reference to FIGS. 6 and 7, separation of the mixed substance by using the zeolite membrane complex 1 will be described. FIG. 6 is a view showing a separation apparatus 2. FIG. 7 is a flowchart showing a flow for separating the mixed substance by the separation apparatus 2.

In the separation apparatus 2, a mixed substance containing a plurality of types of fluids (i.e., gases or liquids) is supplied to the zeolite membrane complex 1, and a substance with high permeability (hereinafter, also referred to as a “high permeability substance”) in the mixed substance is caused to permeate the zeolite membrane complex 1, to be thereby separated from the mixed substance. Separation in the separation apparatus 2 may be performed, for example, in order to extract a high permeability substance from a mixed substance, or in order to concentrate a substance with low permeability (hereinafter, referred to also as a “low permeability substance”).

The mixed substance (i.e., mixed fluid) may be a mixed gas containing a plurality of types of gases, may be a mixed liquid containing a plurality of types of liquids, or may be a gas-liquid two-phase fluid containing both a gas and a liquid.

The mixed substance contains at least one type of, for example, hydrogen (Hz), helium (He), nitrogen (N₂), oxygen (O₂), water (H₂O), carbon monoxide (CO), carbon dioxide (CO₂), nitrogen oxide, ammonia (NH₃), sulfur oxide, hydrogen sulfide (H₂S), sulfur fluoride, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde. The above-described high permeability substance is at least one type of, for example, H₂, He, N₂, O₂, CO₂, NH₃, and H₂O, and preferably H₂O.

The nitrogen oxide is a compound of nitrogen and oxygen. The above-described nitrogen oxide is, for example, a gas called NO_{X} such as nitric oxide (NO), nitrogen dioxide (NO₂), nitrous oxide (also referred to as dinitrogen monoxide) (N₂O), dinitrogen trioxide (N₂O₃), dinitrogen tetroxide (N₂O₄), dinitrogen pentoxide (N₂O₅), or the like.

The sulfur oxide is a compound of sulfur and oxygen. The above-described sulfur oxide is, for example, a gas called SO_{X} such as sulfur dioxide (SO₂), sulfur trioxide (SO₃), or the like.

The sulfur fluoride is a compound of fluorine and sulfur. The above-described sulfur fluoride is, for example, disulfur difluoride (F—S—S—F, S═SF₂), sulfur difluoride (SF₂), sulfur tetrafluoride (SF₄), sulfur hexafluoride (SF₆), disulfur decafluoride (S₂F₁₀), or the like.

The C1 to C8 hydrocarbons are hydrocarbons with not less than 1 and not more than 8 carbon atoms. The C3 to C8 hydrocarbons may be any one of a linear-chain compound, a side-chain compound, and a ring compound. Further, the C2 to C8 hydrocarbons may either be a saturated hydrocarbon (i.e., in which there is no double bond or triple bond in a molecule), or an unsaturated hydrocarbon (i.e., in which there is a double bond and/or a triple bond in a molecule). The C1 to C4 hydrocarbons are, for example, methane (CH₄), ethane (C₂H₆), ethylene (C₂H₄), propane (C₃H₈), propylene (C₃H₆), normal butane (CH₃(CH₂)₂CH₃), isobutane (CH (CH₃)₃), 1-butene (CH₂═CHCH₂CH₃), 2-butene (CH₃CH═CHCH₃), or isobutene (CH₂═C(CH₃)₂).

The above-described organic acid is carboxylic acid, sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethanesulfonic acid (C₂H₆O₃S) or the like. The organic acid may either be a chain compound or a ring compound.

The above-described alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

The mercaptans are an organic compound having hydrogenated sulfur (SH) at the terminal end thereof, and are a substance also referred to as thiol or thioalcohol. The above-described mercaptans are, for example, methyl mercaptan (CH₃SH), ethyl mercaptan (C₂H₅SH), 1-propanethiol (C₃H₇SH), or the like.

The above-described ester is, for example, formic acid ester, acetic acid ester, or the like.

The above-described ether is, for example, dimethyl ether ((CH₃)₂O), methyl ethyl ether (C₂H₅OCH₃), diethyl ether ((C₂H₅)₂O), or the like.

The above-described ketone is, for example, acetone ((CH₃)₂CO), methyl ethyl ketone (C₂H₅COCH₃), diethyl ketone ((C₂H₅)₂CO), or the like.

The above-described aldehyde is, for example, acetaldehyde (CH₃CHO), propionaldehyde (C₂H₅CHO), butanal (butylaldehyde) (C₃H₇CHO), or the like.

In the following description, it is assumed that the mixed substance to be separated by the separation apparatus 2 is a mixed liquid containing a plurality of types of liquids.

The separation apparatus 2 includes the zeolite membrane complex 1, sealing parts 21, a housing 22, two sealing members 23, a supply part 26, a first collecting part 27, and a second collecting part 28. The zeolite membrane complex 1, the sealing parts 21, and the sealing members 23 are placed inside the housing 22. The supply part 26, the first collecting part 27, and the second collecting part 28 are disposed outside the housing 22 and connected to the housing 22.

The sealing parts 21 are members which are attached to both end portions in the longitudinal direction (i.e., in the left and right direction of FIG. 6) of the support 11 and cover and seal both end surfaces in the longitudinal direction of the support 11 and outer surfaces in the vicinity of the end surfaces. The sealing parts 21 prevent inflow and outflow of a liquid from both the end surfaces of the support 11. The sealing part 21 is, for example, a plate-like member formed of glass or a resin. The material and the shape of the sealing part 21 may be changed as appropriate. Further, since the sealing part 21 is formed with a plurality of openings which coincide with the plurality of through holes 111 of the support 11, both ends of each through hole 111 of the support 11 in the longitudinal direction are not covered by the sealing parts 21. Therefore, the liquid or the like can flow into and out from the through hole 111 from both ends thereof.

There is no particular limitation on the shape of the housing 22 but is, for example, a tubular member having a substantially cylindrical shape. The housing 22 is formed of, for example, stainless steel or carbon steel. The longitudinal direction of the housing 22 is substantially in parallel to the longitudinal direction of the zeolite membrane complex 1. A supply port 221 is provided at an end portion on one side in the longitudinal direction of the housing 22 (i.e., an end portion on the left side in FIG. 6), and a first exhaust port 222 is provided at another end portion on the other side. A second exhaust port 223 is provided on a side surface of the housing 22. The supply part 26 is connected to the supply port 221. The first collecting part 27 is connected to the first exhaust port 222. The second collecting part 28 is connected to the second exhaust port 223. An internal space of the housing 22 is an enclosed space that is isolated from the space around the housing 22.

The two sealing members 23 are arranged around the entire circumference between an outer surface of the zeolite membrane complex 1 and an inner surface of the housing 22 in the vicinity of both end portions of the zeolite membrane complex 1 in the longitudinal direction. Each of the sealing members 23 is a substantially annular member formed of a material that the liquid cannot permeate. The sealing member 23 is, for example, an O-ring formed of a flexible resin. The sealing members 23 come into close contact with the outer surface of the zeolite membrane complex 1 and the inner surface of the housing 22 around the entire circumferences thereof. In the exemplary case of FIG. 6, the sealing members 23 come into close contact with outer surfaces of the sealing parts 21 and indirectly come into close contact with the outer surface of the zeolite membrane complex 1 with the sealing parts 21 interposed therebetween. The portions between the sealing members 23 and the outer surface of the zeolite membrane complex 1 and between the sealing members 23 and the inner surface of the housing 22 are sealed, and it is thereby mostly or completely impossible for the liquid to pass through the portions.

The supply part 26 supplies the mixed liquid into the internal space of the housing 22 through the supply port 221. The supply part 26 includes, for example, a pump for pumping the mixed liquid toward the housing 22. The pump includes a temperature regulating part and a pressure regulating part which regulate the temperature and the pressure of the mixed liquid, respectively, to be supplied to the housing 22. The first collecting part 27 includes, for example, a storage container for storing the liquid led out from the housing 22 or a pump for transporting the liquid. The second collecting part 28 includes, for example, a vacuum pump for decompressing a space outside the outer surface of the zeolite membrane complex 1 inside the housing 22 (in other words, a space sandwiched between the two sealing members 23) and a liquid nitrogen trap for cooling and liquefying the gas permeating the zeolite membrane complex 1 while vaporizing.

When separation of the mixed liquid is performed, the above-described separation apparatus 2 is prepared and the zeolite membrane complex 1 is thereby prepared (FIG. 7: Step S21). Subsequently, the supply part 26 supplies a mixed liquid containing a plurality of types of liquids with different permeabilities to the zeolite membrane 12 into the internal space of the housing 22. For example, the main component of the mixed liquid includes water (H₂O) and ethanol (C₂H₅OH). The mixed liquid may contain any liquid other than water or ethanol. The pressure (i.e., feed pressure) of the mixed liquid to be supplied into the internal space of the housing 22 from the supply part 26 is, for example, 0.1 MPa to 2 Mpa, and the temperature of the mixed liquid is, for example, 10° C. to 200° C.

The mixed liquid supplied from the supply part 26 into the housing 22 is fed from the left end of the zeolite membrane complex 1 in this figure into the inside of each through hole 111 of the support 11 as indicated by an arrow 251. A high permeability substance which is a liquid with high permeability in the mixed liquid permeates the zeolite membrane 12 formed on the inner surface of each through hole 111 and the support 11 while vaporizing, and is led out from the outer surface of the support 11. The high permeability substance (for example, water) is thereby separated from a low permeability substance which is a liquid with low permeability (for example, ethanol) in the mixed liquid (Step S22).

The gas (hereinafter, referred to as a “permeate substance”) led out from the outer surface of the support 11 is guided to the second collecting part 28 through the second exhaust port 223 as indicated by an arrow 253 and cooled and collected by the second collecting part 28 as a liquid. The pressure (i.e., permeate pressure) of the gas to be collected by the second collecting part 28 through the second exhaust port 223 is, for example, about 50 Torr (about 6.67 kPa). In the permeate substance, the low permeability substance permeating the zeolite membrane 12 may be included as well as the above-described high permeability substance.

Further, in the mixed liquid, a liquid (hereinafter, referred to as a “non-permeate substance”) other than the substance which has permeated the zeolite membrane 12 and the support 11 passes through each through hole 111 of the support 11 from the left side to the right side in this figure and is collected by the first collecting part 27 through the first exhaust port 222 as indicated by an arrow 252. The pressure of the liquid to be collected by the first collecting part 27 through the first exhaust port 222 is, for example, substantially the same as the feed pressure. The non-permeate substance may include a high permeability substance that has not permeated the zeolite membrane 12, as well as the above-described low permeability substance. The non-permeate substance collected by the first collecting part 27 may be, for example, returned to the supply part 26 and supplied again into the housing 22.

The separation apparatus 2 shown in FIG. 6 may be used, for example, as a membrane reactor. In this case, the housing 22 is used as a reactor. Inside the housing 22, a catalyst for accelerating a chemical reaction of a starting material to be supplied from the supply part 26 is included. The catalyst is placed, for example, between the supply port 221 and the first exhaust port 222. Preferably, the catalyst is placed in the vicinity of the zeolite membrane 12 of the zeolite membrane complex 1. The catalyst having suitable material and shape in accordance with the type of the starting material and the type of the chemical reaction to be caused on the starting material is used. The starting material contains one type of substance or two or more types of substances. The membrane reactor may further include a heating apparatus for heating the reactor (i.e., the housing 22) and the starting material in order to accelerate the chemical reaction of the starting material.

In the separation apparatus 2 used as the membrane reactor, a mixed substance containing a product substance which is generated by the chemical reaction of the starting material under the existence of the catalyst is supplied to the zeolite membrane 12 in the same manner as above, and a high permeability substance in the mixed substance permeates the zeolite membrane 12, to be thereby separated from other substances having a permeability lower than that of the high permeability substance. The mixed substance may be, for example, a fluid containing the product substance and an unreacted starting material. Further, the mixed substance may contain two or more types of product substances. The high permeability substance may be the product substance generated from the starting material or any substance other than the product substance. Preferably, the high permeability substance contains one or more types of product substances.

In the case where the high permeability substance is the product substance generated from the starting material, the product substance is separated from other substances by the zeolite membrane 12 and the yield of the product substance can be thereby increased. In the case where the mixed substance contains two or more types of product substances, the two or more types of product substances may be high permeability substances, and some types of product substances in the two or more types of product substances may be high permeability substances.

Next, Examples of the zeolite membrane complex will be described.

### EXAMPLES

(Preparation of Seed Crystals)

As the aluminum source, the silicon source, the alkali metal source, and the structure-directing agent (SDA), aluminum hydroxide, 30% colloidal silica, rubidium hydroxide, and tetramethylammonium hydroxide, respectively, are dissolved in pure water, and a starting material solution having a composition in the molar ratio of 1 Al₂O₃:30 SiO₂:5 Rb₂O:5 SDA: 1500H₂O is thereby prepared. This starting material solution is hydrothermally synthesized at 180° C. for 100 hours. The crystals obtained by the hydrothermal synthesis are collected and sufficiently washed by pure water, and then completely dried at 100° C. As a result of X-ray diffraction analysis, the obtained crystals are ETL crystals. These crystals are put into pure water so as to have a concentration of 10 to 20 mass % and pulverized by using a ball mill, to thereby become seed crystals.

(Preparation of ETL Membrane)

A monolith-like porous alumina support is brought into contact with a solution in which the above-described seed crystals are dispersed, and the seed crystals are applied inside the cell. After that, as the aluminum source, the silicon source, the alkali metal source, and the structure-directing agent (SDA), aluminum hydroxide, 30% colloidal silica, rubidium hydroxide, sodium hydroxide, and tetramethylammonium hydroxide, respectively, are dissolved in pure water, and a starting material solution having a composition in the molar ratio of 1 Al₂O₃:30 SiO₂:15 Rb₂O:6 Na₂O:10 SDA:3000H₂O is thereby prepared. The alumina support with the seed crystals applied thereto is immersed in this starting material solution and hydrothermally synthesized at 180° C. for 15 hours. After the hydrothermal synthesis, an ETL-type zeolite membrane (hereinafter, referred to simply as an “ETL membrane”) formed on the support is sufficiently washed by pure water and subsequently, dried completely at 100° C. After drying, the N₂ permeance through the ETL membrane is measured to be not higher than 0.05 nmol/m²·s·Pa. It is thereby confirmed that the ETL membrane has denseness to a practical degree. Next, a heat treatment is performed on the ETL membrane at 500° C. for 20 hours, to thereby burn and remove the SDA and penetrate the pores in the ETL membrane. The CF₄ gas permeance of the obtained ETL membrane is measured to be not higher than 10 nmol/m²·s·Pa. Further, the molar ratio of silicon/aluminum in the ETL membrane, which is measured by EDS analysis, is not lower than 3.

(Evaluation of ETL Membrane)

By circulating 50 mass % aqueous ethanol solution heated to 50° C. by a circulation pump, the aqueous ethanol solution is supplied to a supply-side space of a container for separation (see the separation apparatus 2 in FIG. 6) set with the ETL membrane, and a permeate-side space is decompressed by the vacuum pump while the pressure therein is controlled to be 50 Torr by a pressure controller and then vapor permeating the ETL membrane and the support is collected by the liquid nitrogen trap. The amount and concentration of the liquid collected by the liquid nitrogen trap are measured, and the water selectivity of the ETL membrane and the water flux are obtained. The water selectivity of the ETL membrane is obtained by dividing the water concentration (mass %) in the collected liquid by the ethanol concentration (mass %) in the collected liquid. The water flux is obtained from the amount of water in the collected liquid. The water selectivity of the ETL membrane is 50, and the water flux is 0.3 kg/m²·h. Thus, the obtained ETL membrane is a membrane showing the water selectivity.

In an X-ray diffraction pattern obtained by X-ray irradiation onto a membrane surface of the ETL membrane, the intensity of the peak existing in the vicinity of 2θ=9.9° and the intensity of the peak existing in the vicinity of 2θ=19.8° are each not lower than 1.0 times the intensity of the peak existing in the vicinity of 2θ=7.9°. Further, in the X-ray diffraction analysis, an X-ray diffraction apparatus manufactured by Rigaku Corporation (apparatus name: MiniFlex 600) is used, and the conditions are that the tube voltage is 40 kV, the tube current is 15 mA, the scanning speed is 0.5°/min, and the scanning step is 0.02°. Further, other conditions are that the divergence slit is 1.25°, the scattering slit is 1.25°, the receiving slit is 0.3 mm, the incident solar slit is 5.0°, and the light-receiving solar slit is 5.0°. No monochromator is used, and as a CuKβ ray filter, used is a nickel foil having a thickness of 0.015 mm.

Further, in a case where the ETL membrane is prepared by using a starting material solution prepared so that in the mixing ratio of raw materials, the molar ratio of silicon/aluminum is 10 to 100, the molar ratio of alkali metal/aluminum is 15 to 100, and the molar ratio of water/aluminum is 2000 to 10000, in the X-ray diffraction pattern obtained by X-ray irradiation onto the membrane surface of the ETL membrane, the intensity of the peak existing in the vicinity of 2θ=9.9° and the intensity of the peak existing in the vicinity of 2θ=19.8° are each not lower than 0.8 times the intensity of the peak existing in the vicinity of 2θ=7.9°. The obtained ETL membrane is a membrane that has high denseness and shows the water selectivity. Especially, it is confirmed that the ETL membrane in which the intensity of the peak existing in the vicinity of 2θ=9.9° and the intensity of the peak existing in the vicinity of 2θ=19.8° are each not lower than 1.0 times the intensity of the peak existing in the vicinity of 2θ=7.9° has denseness higher than that of the ETL membrane in which the intensity of the peak existing in the vicinity of 2θ=9.9° and the intensity of the peak existing in the vicinity of 2θ=19.8° are each not lower than 0.8 times and lower than 1.0 times the intensity of the peak existing in the vicinity of 2θ=7.9°.

### Comparative Examples

(Preparation of Seed Crystals)

The seed crystals are prepared in the same manner as in Examples.

(Preparation of ETL Membrane)

A monolith-like porous alumina support is brought into contact with the solution in which the above-described seed crystals are dispersed, and the seed crystals are applied inside the cell. The starting material solution having the same composition as that in the preparation of the seed crystals is prepared, and the alumina support with the seed crystals applied thereto is immersed in this starting material solution and hydrothermally synthesized at 180° C. for 15 hours. After the hydrothermal synthesis, the ETL membrane is sufficiently washed by pure water and subsequently, dried completely at 100° C. After drying, the N₂ permeance through the ETL membrane is measured to be not lower than 1 nmol/m²·s·Pa. It is thereby confirmed that the ETL membrane has no denseness. Next, the heat treatment is performed on the ETL membrane at 500° C. for 20 hours, to thereby burn and remove the SDA and penetrate the pores in the ETL membrane. The CF₄ gas permeance of the obtained ETL membrane is measured to be higher than 50 nmol/m²·s·Pa.

(Evaluation of ETL Membrane)

By circulating 50 mass % aqueous ethanol solution heated to 50° C. by the circulation pump, the aqueous ethanol solution is supplied to the supply-side space of the container for separation set with the ETL membrane, and when the permeate-side space is decompressed by the vacuum pump while the pressure therein is controlled to be 50 Torr by the pressure controller, the aqueous ethanol solution disadvantageously permeates the ETL membrane and the support as it is. Thus, the obtained ETL membrane is a membrane that has low denseness and does not show the water selectivity.

In the X-ray diffraction pattern obtained by X-ray irradiation onto the membrane surface of the ETL membrane, the intensity of the peak existing in the vicinity of 2θ=9.9° and the intensity of the peak existing in the vicinity of 2θ=19.8° are each lower than 0.8 times the intensity of the peak existing in the vicinity of 2θ=7.9°.

As described above, the zeolite membrane complex 1 includes the porous support 11 and the zeolite membrane 12 formed on the support 11 and composed of ETL-type zeolite. In the X-ray diffraction pattern obtained by X-ray irradiation onto the surface of the zeolite membrane 12, the intensity of the peak existing in the vicinity of 2θ=9.9° and the intensity of the peak existing in the vicinity of 2θ=19.8° are each not lower than 0.8 times the intensity of the peak existing in the vicinity of 2θ=7.9°. Thus, the zeolite membrane 12 is an oriented membrane in which the c-axis of constituent grains thereof is oriented in a direction substantially perpendicular to the membrane surface, and the denseness of the zeolite membrane 12 is thereby increased. As a result, it is thereby possible to easily provide the zeolite membrane complex 1 having the ETL-type zeolite membrane with increased denseness.

Preferably, in the X-ray diffraction pattern, the intensity of the peak existing in the vicinity of 2θ=9.9° and the intensity of the peak existing in the vicinity of 2θ=19.8° are each not lower than 1.0 times the intensity of the peak existing in the vicinity of 2θ=7.9°. This further increases the denseness of the zeolite membrane 12.

Preferably, in the zeolite membrane 12, the molar ratio of silicon/aluminum is not lower than 3. This improves the heat resistance and the acid resistance of the zeolite membrane 12. It is preferable that in the zeolite membrane 12, the CF₄ gas permeance is not higher than 10 nmol/m²·s·Pa.

The method of producing the above-described zeolite membrane complex 1 includes a step of depositing the seed crystals composed of ETL-type zeolite, onto the porous support 11 and a step of forming the zeolite membrane 12 on the support 11 by immersing the support 11 in the starting material solution and performing hydrothermal synthesis to grow the ETL-type zeolite from the seed crystals. Further, in the starting material solution, the molar ratio of silicon/aluminum is 10 to 100, the molar ratio of alkali metal/aluminum is 15 to 100, and the molar ratio of water/aluminum is 2000 to 10000. It is thereby possible to easily provide the zeolite membrane complex 1 having the ETL-type zeolite membrane with increased denseness.

As described above, the separation apparatus 2 includes the above-described zeolite membrane complex 1 and the supply part 26 for supplying a mixed substance containing a plurality of types of gases or liquids to the zeolite membrane complex 1. The zeolite membrane complex 1 separates a high permeability substance having a high permeability in the mixed substance from other substances by allowing the high permeability substance to permeate the zeolite membrane complex 1. It is thereby possible to efficiently separate the high permeability substance from other substances.

As described above, the membrane reactor includes the above-described zeolite membrane complex 1, the catalyst for accelerating a chemical reaction of a starting material, the reactor (the housing 22 in the above-described exemplary case) that includes the zeolite membrane complex 1 and the catalyst, and the supply part 26 for supplying the starting material to the reactor. The zeolite membrane complex 1 separates a high permeability substance having a high permeability in a mixed substance from other substances by allowing the high permeability substance to permeate the zeolite membrane complex 1, in which the mixed substance contains a product substance generated by a chemical reaction of the starting material under the existence of the catalyst. Like above, it is thereby possible to efficiently separate the high permeability substance from other substances.

In the zeolite membrane complex 1, the separation apparatus 2, the membrane reactor, and the method of producing the zeolite membrane complex 1, which are described above, various modifications can be made.

In the zeolite membrane 12, the molar ratio of silicon/aluminum may be lower than 3. If there is no problem in the use of the zeolite membrane complex 1, in the zeolite membrane 12, the CF₄ gas permeance may be higher than 10 nmol/m²·s·Pa.

In the support 11 having a through hole(s), the zeolite membrane 12 may be formed on either one of the inner surface(s) and the outer surface thereof or both of the inner surface(s) and the outer surface.

The zeolite membrane complex 1 may be produced by any method other than the above-described production method.

The zeolite membrane complex 1 may further include a function layer or a protective layer laminated on the zeolite membrane 12, additionally to the support 11 and the zeolite membrane 12. Such a function layer or a protective layer may be an inorganic membrane such as the zeolite membrane, a silica membrane, a carbon membrane, or the like or an organic membrane such as a polyimide membrane, a silicone membrane, or the like. Further, a substance that is easy to adsorb water may be added to the function layer or the protective layer laminated on the zeolite membrane 12.

In the separation apparatus 2 and the separation method, the separation of the mixed substance may be performed by a vapor permeation method, a reverse osmosis method, a gas permeation method, or the like other than the pervaporation method exemplarily shown in the above description. The same applies to the membrane reactor.

In the separation apparatus 2 and the separation method, any substance other than the substances exemplarily shown in the above description may be separated from the mixed substance. The same applies to the membrane reactor.

The configurations in the above-described preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The zeolite membrane complex of the present invention can be used, for example, as a dehydration membrane, and can be further used in various fields in which zeolite is used as a separation membrane for any of various substances other than water, an adsorption membrane for any of various substances, or the like.

### REFERENCE SIGNS LIST

1 Zeolite membrane complex
11 Support
12 Zeolite membrane
S11 to S14, S21, S22 Step

1. A zeolite membrane complex, comprising:
a porous support; and
a zeolite membrane formed on said support and composed of ETL-type zeolite,
wherein in an X-ray diffraction pattern obtained by X-ray irradiation onto a surface of said zeolite membrane, an intensity of a peak existing in vicinity of 2θ=9.9° and an intensity of a peak existing in vicinity of 2θ=19.8° are each not lower than 0.8 times an intensity of a peak existing in vicinity of 2θ=7.9°.

2. The zeolite membrane complex according to claim 1, wherein
in said X-ray diffraction pattern, the intensity of the peak existing in vicinity of 2θ=9.9° and the intensity of the peak existing in vicinity of 2θ=19.8° are each not lower than 1.0 times the intensity of the peak existing in vicinity of 2θ=7.9°.

3. The zeolite membrane complex according to claim 1, wherein
in said zeolite membrane, a molar ratio of silicon/aluminum is not lower than 3.

4. The zeolite membrane complex according to claim 1, wherein
in said zeolite membrane, CF₄ gas permeance is not higher than 10 nmol/m²·s·Pa.

5. The zeolite membrane complex according to claim 1, wherein
said zeolite membrane contains rubidium.

6. The zeolite membrane complex according to claim 1, wherein
in said zeolite membrane, a molar ratio of alkali metal/aluminum is 0.01 to 1.

7. A separation apparatus, comprising:
the zeolite membrane complex according to claim 1; and
a supply part for supplying a mixed substance containing a plurality of types of gases or liquids to said zeolite membrane complex,
wherein said zeolite membrane complex separates a high permeability substance having a high permeability in said mixed substance from other substances by allowing said high permeability substance to permeate said zeolite membrane complex.

8. A membrane reactor, comprising:
the zeolite membrane complex according to claim 1;
a catalyst for accelerating a chemical reaction of a starting material;
a reactor that includes said zeolite membrane complex and said catalyst; and
a supply part for supplying said starting material to said reactor,
wherein said zeolite membrane complex separates a high permeability substance having a high permeability in a mixed substance from other substances by allowing said high permeability substance to permeate said zeolite membrane complex, the mixed substance containing a product substance generated by a chemical reaction of said starting material under existence of said catalyst.

9. A method of producing a zeolite membrane complex, comprising:
a) depositing seed crystals composed of ETL-type zeolite, onto a porous support; and
b) forming a zeolite membrane on said support by immersing said support in a starting material solution and performing hydrothermal synthesis to grow ETL-type zeolite from said seed crystals,
wherein in said starting material solution, a molar ratio of silicon/aluminum is 10 to 100, a molar ratio of alkali metal/aluminum is 15 to 100, and a molar ratio of water/aluminum is 2000 to 10000.
